(19) United States
(12) Patent Application Publication
(10) Pub. No.: US 2025/0117290 A1
(43) Pub. Date: Apr. 10, 2025

(54) SYSTEMS AND METHODS FOR CACHE-COHERENT PERSISTENT MEMORY WITH COMPREHENSIVE DATA PROTECTION

(71) Applicant: SAMSUNG ELECTRONICS CO., LTD., Suwon-si (KR)

(72) Inventors: Zongwang LI, Dublin, CA (US); Da Zhang, Blacksburg, VA (US); Shuyi Pei, Santa Clara, CA (US); Rekha Pitchumani, Oak Hill, VA (US); Yang Seok Ki, Palo Alto, CA (US)

(73) Assignee: SAMSUNG ELECTRONICS CO., LTD., Suwon-si (KR)

(21) Appl. No.: 18/793,368

(22) Filed: Aug. 2, 2024

Related U.S. Application Data
(60) Provisional application No. 63/543,389, filed on Oct. 10, 2023.

(51) Int. Cl. G06F 11/10; G06F 11/07

(52) U.S. Cl. CPC G06F 11/1068; G06F 11/076; G06F 11/1004

(57) ABSTRACT

A cache-coherent persistent memory (PMEM) device includes an input/output (I/O) interface; a volatile memory module; an error correction module which is configurable according to an I/O protocol; a non-volatile storage module; and at least one processor configured to: receive a store command and data corresponding to the store command from a host device through the I/O interface, based on the store command, control the volatile memory module to store the data, control the error correction module to encode the data to generate encoded data, and control the non-volatile storage module to store the encoded data.

### CROSS-REFERENCE TO RELATED APPLICATION

This application claims the priority benefit under 35 U.S.C. § 119 (e) of U.S. Provisional Application No. 63/543,389, filed on Oct. 10, 2023, the disclosure of which is incorporated by reference in its entirety.

### BACKGROUND

### 1. Field

The disclosure relates to cache-coherent Persistent Memory (PMEM) devices, and more particularly to error correction within cache-coherent PMEM devices.

### 2. Description of Related Art

A persistent memory (PMEM) device may include a device memory which may be implemented using a volatile memory device which may lose data when power supplied to the PMEM device is lost or interrupted, and persistent backend storage which may be implemented using a non-volatile storage which maintains data when the power supplied to the PMEM device is lost or interrupted. Persistence of data stored in the device memory may be achieved by dumping or flushing the data from the device memory to the persistent backend storage.

In some PMEM designs, there may be a mismatch between the error rate of the device memory and the error rate of the persistent backend storage. In addition, there may be no error protection mechanism (e.g., error detection and correction) between the device memory and the persistent backend storage. Therefore, based the overall error rate of the PMEM device may not be sufficient to meet system requirements for memory.

### SUMMARY

Therefore, embodiments of the present disclosure may provide an error correction capability between a device memory and a persistent backend storage included in a PMEM device, which may be sufficient to close an error rate gap between the device memory and the persistent backend storage, allowing the overall error rate of the PMEM device to be improved.

In an embodiment, a cache-coherent PMEM device may include an I/O interface; a volatile memory module; an error correction module which is configurable according to an I/O protocol; a non-volatile storage module; and at least one processor configured to: receive a store command and data corresponding to the store command from a host device through the I/O interface according to a cache-coherent memory protocol, based on the store command, control the volatile memory module to store the data, control the error correction module to encode the data to generate encoded data, and control the non-volatile storage module to store the encoded data.

In an embodiment, a cache-coherent PMEM device may include an I/O interface; a volatile memory module; an encoder module and a decoder module which are configurable according to an I/O protocol; a non-volatile storage module; and at least one processor configured to: based on receiving a store command and data corresponding to the store command from a host device through the I/O interface according to a cache-coherent memory protocol, control the volatile memory module to store the data, based on at least one from among detecting a change in a power state of the cache-coherent PMEM device, and receiving a flush command from the host device through the I/O interface according to the I/O protocol, control the encoder module to encode the data to generate encoded data, and control the non-volatile storage module to store the encoded data, control the decoder module to decode the encoded data to reconstruct the data, control the volatile memory module to store the data, and based on receiving a load command from the host device through the I/O interface according to the cache-coherent memory protocol, provide the data to the host device through the I/O interface.

In an embodiment, a method of operating cache-coherent PMEM device may include receiving a store command and data corresponding to the store command from a host device through an I/O interface according to a cache-coherent memory protocol; based on the store command, storing the data in a volatile memory module; encoding the data using an error correction module to generate encoded data, wherein the encoding module is configurable according to an I/O protocol; and storing the encoded data in a non-volatile storage module.

### BRIEF DESCRIPTION OF DRAWING

In the following section, the aspects of the subject matter disclosed herein will be described with reference to exemplary embodiments illustrated in the figures, in which:

FIG. 1 is a block diagram showing an example of a memory system, according to embodiments;

FIG. 2 is a block diagram showing an example of memory system, according to embodiments;

FIG. 3 is a block diagram showing an example of a cache-coherent PMEM device, according to embodiments;

FIG. 4A is a block diagram showing an example of an error correction module, according to embodiments;

FIG. 4B is a block diagram showing an example of an error correction module, according to embodiments;

FIG. 5 is a block diagram showing an example of a non-volatile storage module, according to embodiments;

FIG. 6 is a flow chart of a process for operating a cache-coherent PMEM device, according to embodiments;

FIG. 7 is a flow chart of a process for operating a cache-coherent PMEM device, according to embodiments;

FIG. 8 is a flow chart of a process for operating a cache-coherent PMEM device, according to embodiments.

### DETAILED DESCRIPTION

In the following detailed description, numerous specific details are set forth in order to provide a thorough understanding of the disclosure. It will be understood, however, by those skilled in the art that the disclosed aspects may be practiced without these specific details. In other instances, well-known methods, procedures, components and circuits have not been described in detail to not obscure the subject matter disclosed herein.

Reference throughout this specification to “one embodiment” or “an embodiment” means that a particular feature, structure, or characteristic described in connection with the embodiment may be included in at least one embodiment disclosed herein. Thus, the appearances of the phrases “in one embodiment” or “in an embodiment” or “according to one embodiment” (or other phrases having similar import) in various places throughout this specification may not necessarily all be referring to the same embodiment. Furthermore, the particular features, structures or characteristics may be combined in any suitable manner in one or more embodiments. In this regard, as used herein, the word “exemplary” means “serving as an example, instance, or illustration.” Any embodiment described herein as “exemplary” is not to be construed as necessarily preferred or advantageous over other embodiments. Additionally, the particular features, structures, or characteristics may be combined in any suitable manner in one or more embodiments. Also, depending on the context of discussion herein, a singular term may include the corresponding plural forms and a plural term may include the corresponding singular form. Similarly, a hyphenated term (e.g., “two-dimensional,” “pre-determined,” “pixel-specific,” etc.) may be occasionally interchangeably used with a corresponding non-hyphenated version (e.g., “two dimensional,” “predetermined,” “pixel specific,” etc.), and a capitalized entry (e.g., “Counter Clock,” “Row Select,” “PIXOUT,” etc.) may be interchangeably used with a corresponding non-capitalized version (e.g., “counter clock,” “row select,” “pixout,” etc.). Such occasional interchangeable uses shall not be considered inconsistent with each other.

Also, depending on the context of discussion herein, a singular term may include the corresponding plural forms and a plural term may include the corresponding singular form. It is further noted that various figures (including component diagrams) shown and discussed herein are for illustrative purpose only, and are not drawn to scale. For example, the dimensions of some of the elements may be exaggerated relative to other elements for clarity. Further, if considered appropriate, reference numerals have been repeated among the figures to indicate corresponding and/or analogous elements.

The terminology used herein is for the purpose of describing some example embodiments only and is not intended to be limiting of the claimed subject matter. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being on, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

The terms “first,” “second,” etc., as used herein, are used as labels for nouns that they precede, and do not imply any type of ordering (e.g., spatial, temporal, logical, etc.) unless explicitly defined as such. Furthermore, the same reference numerals may be used across two or more figures to refer to parts, components, blocks, circuits, units, or modules having the same or similar functionality. Such usage is, however, for simplicity of illustration and ease of discussion only; it does not imply that the construction or architectural details of such components or units are the same across all embodiments or such commonly-referenced parts/modules are the only way to implement some of the example embodiments disclosed herein.

Unless otherwise defined, all terms (including technical and scientific terms) used herein have the same meaning as commonly understood by one of ordinary skill in the art to which this subject matter belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, the term “module” refers to any combination of software, firmware and/or hardware configured to provide the functionality described herein in connection with a module. For example, software may be embodied as a software package, code and/or instruction set or instructions, and the term “hardware,” as used in any implementation described herein, may include, for example, singly or in any combination, an assembly, hardwired circuitry, programmable circuitry, state machine circuitry, and/or firmware that stores instructions executed by programmable circuitry. The modules may, collectively or individually, be embodied as circuitry that forms part of a larger system, for example, but not limited to, an integrated circuit (IC), system on-a-chip (SoC), an assembly, and so forth.

A persistent memory (PMEM) device may include a device memory which may be implemented using a volatile memory device such as a dynamic random access memory (DRAM), and persistent backend storage which may be implemented using a non-volatile storage device such as NAND flash device, for example a nonvolatile memory express (NVMe) solid-state drive (SSD). Persistence of data stored in the device memory may be achieved by dumping the data from the device memory to the persistent backend storage. In some PMEM designs, there may be a mismatch between an error rate of the device memory and an error rate of the persistent backend storage. For example, the uncorrectable bit error rate (UBER) requirement for a consumer SSD may be 10-15, and the UBER requirement for an enterprise SSD may be 10-16, while the UBER requirement for DRAM device may be lower by several orders of magnitude. In addition, there may be no error protection mechanism (e.g., error detection and correction) between the device memory and the persistent backend storage. Therefore, based on the error rate of the persistent backend storage, the overall error rate of the PMEM device may not be sufficient to meet system requirements for memory.

Therefore, embodiments of the present disclosure may provide an error correction capability between a device memory and a persistent backend storage included in a PMEM device. For example, a cyclic redundancy check (CRC) scheme may be implemented between the device memory and the persistent backend storage to achieve comprehensive data protection. As another example, a relatively low-cost error correction code (ECC) scheme may be implemented between the device memory and the persistent backend storage to allow correction of errors that may occur when data is transferred between the device memory and the persistent backend storage. According to embodiments, the error correction capability may be sufficient to close an error rate gap between the device memory and the persistent backend storage, which may allow the overall error rate of the PMEM device to be improved.

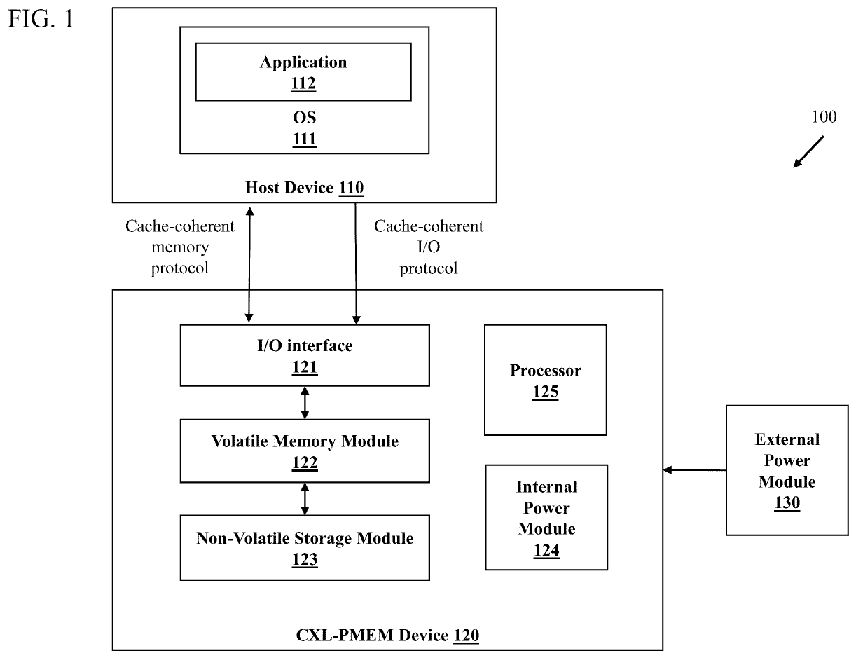

FIG. 1 is a block diagram showing an example of a memory system, according to embodiments. As shown in FIG. 1, the memory system 100 may include a host device 110, a cache-coherent PMEM device 120, and an external power module 130 which may provide power to the cache-coherent PMEM device 120.

According to embodiments, the cache-coherent PMEM device 120 may operate according to a cache-coherent protocol. A cache-coherent protocol may allow cache coherence to be maintained in multi-device or multi-processor systems. For example, in some systems, shared data may be stored in multiple different caches, and if the data is changed in one cache and is not changed in another cache, this data incoherence may cause processing errors. Accordingly, cache-coherent protocols may be used to maintain data coherency between caches, for example by invalidating or updating caches based on changes made in other caches.

The Compute Express Link (CXL) standard may include examples of a cache-coherent protocol. CXL may be implemented using three protocols, for example a CXL.io protocol, a CXL.cache protocol, and a CXL.mem protocol, which may be dynamically multiplexed on a Peripheral Component Interconnect Express (PCIe) physical layer. The CXL.io protocol may be based on PCIe, and may be used for device discovery, status reporting, virtual to physical address translation, and direct memory access (DMA). The CXL.io protocol may use the non-coherent load-store semantics of PCIe. The CXL.cache protocol may be used by a host device to cache system memory. The CXL.mem protocol may be an example of a cache-coherent memory protocol, which may make it possible for a CXL memory device attached to a host device to be cacheable (which may be referred to as Host-managed Device Memory (HDM)), similar to the host memory, resulting in a host's uniform view across HDM and host memory.

CXL may be used in various types of devices. For example, CXL Type 1 devices may include accelerators such as smart network interface cards (NICs) that use coherency semantics along with PCIe-style Direct Memory Access (DMA) transfers. Thus, CXL Type 1 devices may implement only the CXL.io and the CXL.cache protocols. CXL Type 2 devices may include accelerators such as general purpose graphics processing units (GP-GPUs) and field-programmable gate arrays (FPGAs) with local memory that can be mapped in part to the cacheable system memory. These devices may also cache system memory for processing. Thus, they implement the CXL.io, CXL.cache and CXL.mem protocols. Type 3 CXL devices may be used for memory bandwidth and capacity expansion, and may be used to connect to different memory types, including supporting multiple memory tiers attached to the host device. Therefore, CXL Type 3 devices may implement only the CXL.io and CXL.mem protocols. According to embodiments, the cache-coherent PMEM device 120 may correspond to a CXL Type 3 device, however embodiments are not limited thereto.

The host device 110 may include a central processing unit (CPU) on which an operating system (OS) 111 may operate, and an application 112 may be executed on the OS 111. In addition, the cache-coherent PMEM device 120 may include an input/output (I/O) interface 121, a volatile memory module 122, a non-volatile storage module 123, a processor 125, and an internal power module 124. In embodiments, the processor 125 may control operations of the cache-coherent PMEM device 120. In embodiments, the volatile memory module 122 may be referred to as a device memory, and the non-volatile storage module 123 may be referred to as a persistent backend storage, but embodiments are not limited thereto.

At least one of the host device 110, the OS 111, and the application 112 may transmit one or more commands to the cache-coherent PMEM device 120. For example, the host device 110 may transmit a command according to an I/O protocol to the cache-coherent PMEM device 120. As another example, the host device 110 may transmit a store command according to a cache-coherent memory protocol to the cache-coherent PMEM device 120, and based on the store command being received at the I/O interface 121, the processor 125 may control the volatile memory module 122 to store data corresponding to the store command. Then, the processor 125 may control the non-volatile storage module 123 to receive the data from the volatile memory module 122 and store the data, which may be referred to as flushing or dumping the data to the non-volatile storage module 123. In some embodiments, the I/O protocol may correspond to the CXL.io protocol, and the cache-coherent memory protocol may correspond to the CXL.mem protocol, but embodiments are not limited thereto.

In embodiments, data stored in the volatile memory module 122 may be lost if power is not supplied to the volatile memory module 122, however data stored in the non-volatile storage module may be maintained even if power is not supplied to the non-volatile storage module 123. Therefore, in some embodiments, the data may be flushed or dumped from the volatile memory module 122 to the non-volatile storage module 123 in order to ensure that the data is not lost due to a power failure. For example, based on detecting a change in a power state of the cache-coherent PMEM device 120, for example an interruption or other failure in power supplied to the cache-coherent PMEM device 120 by the external power module 130, the processor 125 may control the cache-coherent PMEM device 120 to use power supplied by the internal power module 124 to flush or dump the data from the volatile memory module 122 to the non-volatile storage module 123. As another example, the processor 125 may control the cache-coherent PMEM device 120 to flush or dump the data from the volatile memory module 122 to the non-volatile storage module 123 based on the cache-coherent PMEM device 120 receiving a flush command from the host device 110. According to embodiments, the flush command may be received according to the I/O protocol. In some embodiments, the flush command may be a global persistent flush (GPF) command, but embodiments are not limited thereto.

After being stored in the non-volatile storage module 123, the data may be returned to the volatile memory module 122, for example after the power supplied by the external power module 130 is restored. The host device 110 may transmit a load command according to the cache-coherent memory protocol to the cache-coherent PMEM device 120, and based on the load command being received at the interface 121, the processor 125 may control the volatile memory module 122 to provide the data corresponding to the load command to the host device 110 through the I/O interface 121.

In embodiments, the volatile memory module 122 may include a random-access memory (RAM) device, for example a dynamic RAM (DRAM) device. However, embodiments are not limited thereto, and according to embodiments the volatile memory module 122 may include any type of volatile memory device. In embodiments, the non-volatile storage device 123 may be a NAND storage device, for example a non-volatile memory express (NVMe) solid-state drive (SSD).

As discussed above, there may be a mismatch or gap between the uncorrectable bit error rate (UBER) requirements of the device memory (e.g., the volatile memory module 122) and the persistent storage backend (e.g., the non-volatile storage module 123). For example, the UBER of a consumer SSD may be 10-15 and the UBER of an enterprise SSD may be 10-16, while the UBER of a DRAM device may be lower by several orders of magnitude. In addition, there may be no error protection mechanism (e.g., error detection and correction) between the device memory and the persistent backend storage. Therefore, based on the UBER of the persistent backend storage, the overall UBER of the cache-coherent PMEM device 120 may not be sufficient to meet system requirements for memory.

Therefore, some embodiments of the present disclosure may provide an error correction capability between a device memory and a persistent backend storage included in a cache-coherent PMEM device.

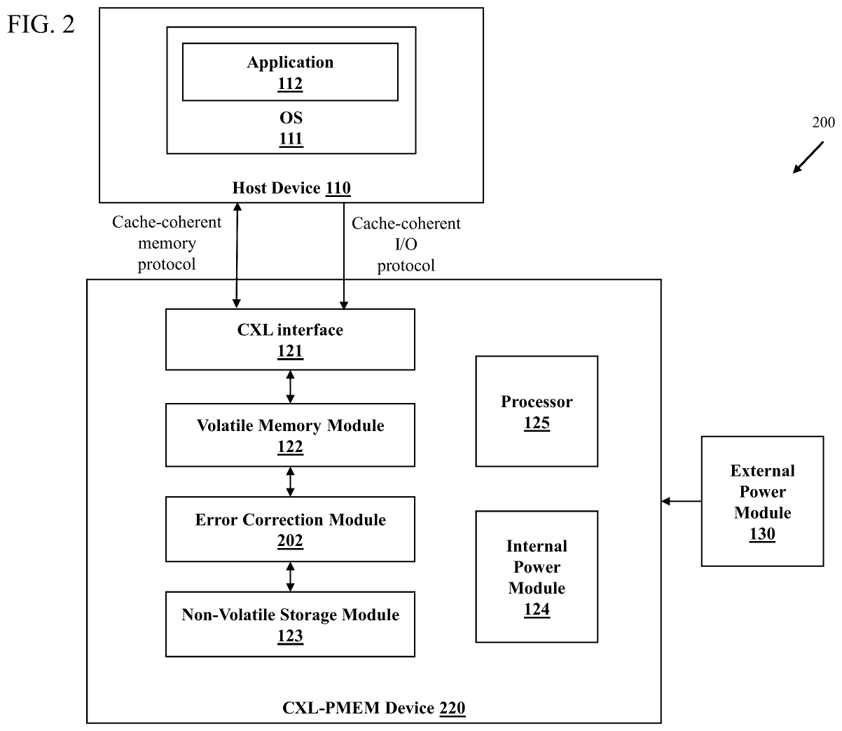

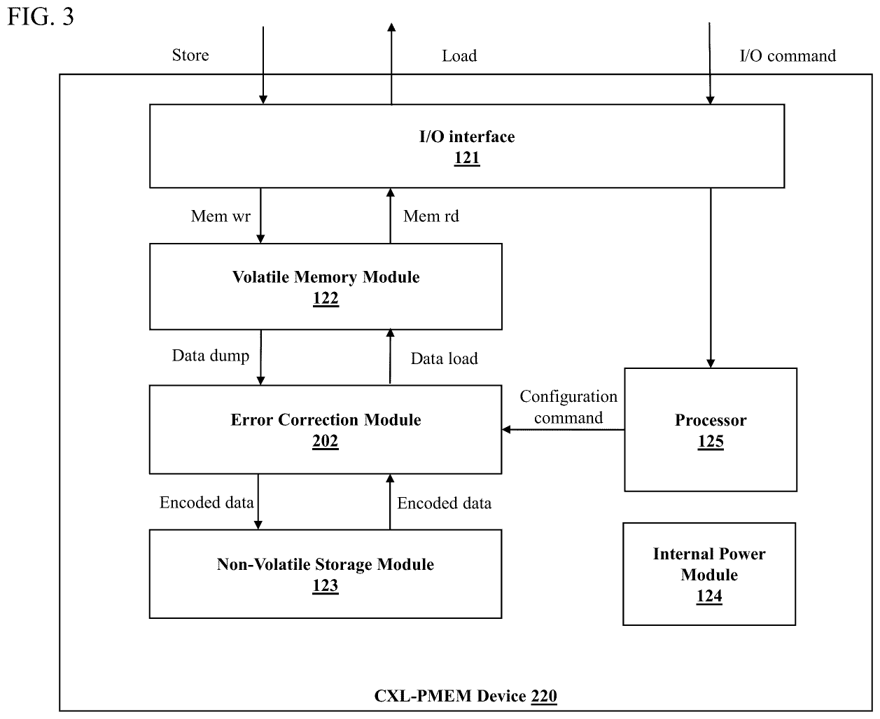

FIG. 2 is a block diagram showing an example of storage system, according to embodiments. FIG. 3 is a block diagram showing an example of a cache-coherent PMEM device, according to embodiments. As shown in FIG. 2, the memory system 200 may be similar to the memory system 100 discussed above. For example, the memory system 200 may include a host device 110 which includes an OS 111 and an application 112. Further, a cache-coherent PMEM device 220 included in the memory system 200 may include an I/O interface 121, a volatile memory module 122, a non-volatile storage module 123, a processor 125, and an internal power module 124, and the cache-coherent PMEM device 220 may receive power supplied by an external power module 130. In some embodiments, the cache-coherent PMEM device 220 may correspond to a CXL Type 3 device, however embodiments are not limited thereto.

However, as shown in FIGS. 2 and 3, the memory system 200 may differ from the memory system 100 in that the cache-coherent PMEM device 220 may further include an error correction module 202, which may communicate with the volatile memory module 122 and the non-volatile storage module 123.

When the cache-coherent PMEM device 220 moves the data from the volatile memory module 122 to the non-volatile storage module 123, for example when the data is flushed or dumped from the volatile memory module 122 to the non-volatile storage module 123 based on a power failure being detected, the processor 125 may control the error correction module 202 to perform a protection procedure on the data before the data is stored in the non-volatile storage module 123. For example, the processor 125 may control the error correction module 202 to receive the data from the volatile memory module 122, and to encode the data before controlling the non-volatile storage module 123 to store the encoded data. Then, when the cache-coherent PMEM device 220 moves the data from the non-volatile storage module 123 to the volatile memory module 122, for example based on the power failure being corrected, the processor 125 may control the error correction module 202 to receive the data from the non-volatile storage module 123, and to decode the encoded data in such a way that one or more errors in the received data are corrected, before controlling the volatile memory module 122 to store the decoded data. For example, the error correction module 202 may apply at least one from among cyclic redundancy check (CRC) coding and error correction code (ECC) coding to the data in order to detect and correct errors. For example, the CRC coding may be used to detect errors in the data, and the ECC coding may be used to correct the errors in the data, however embodiments are not limited thereto. Examples of the encoding and decoding are discussed below.

In embodiments, the error correction module 202 may be configurable according to the I/O protocol. For example, the host device 110 may transmit a command according to the I/O protocol (illustrated as “I/O command” in FIG. 3) to the cache-coherent PMEM device 220, and based on the command being received at the I/O interface 121, the processor 125 may configure one or more parameters of the error correction module 202, for example by using a configuration command. For example, the processor 125 may control the error correction module 202 to be enabled or disabled, or may configure one or more parameters of the error correction module 202, for example a type of the encoding or decoding which is applied to the data by the error correction module 202. Examples of the configuration process are discussed below.

Therefore, according to embodiments, the cache-coherent PMEM device 220 may provide end-to-end or otherwise comprehensive protection to the data, and may eliminate or reduce any error rate gap between the volatile memory module 122 (e.g., the device memory) and the non-volatile storage module 123 (e.g., the persistent backend storage). Therefore, the performance of the cache-coherent PMEM device 220 may be improved in comparison with the cache-coherent PMEM device 120 discussed above. For example, an overall UBER of the cache-coherent PMEM device 220 may be lower than an overall UBER of the cache-coherent PMEM device 120 discussed above.

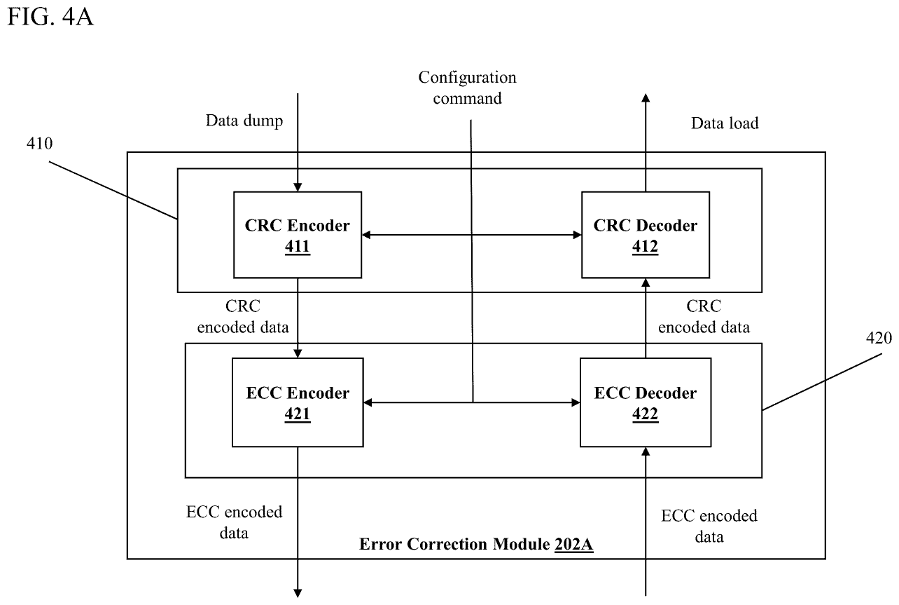

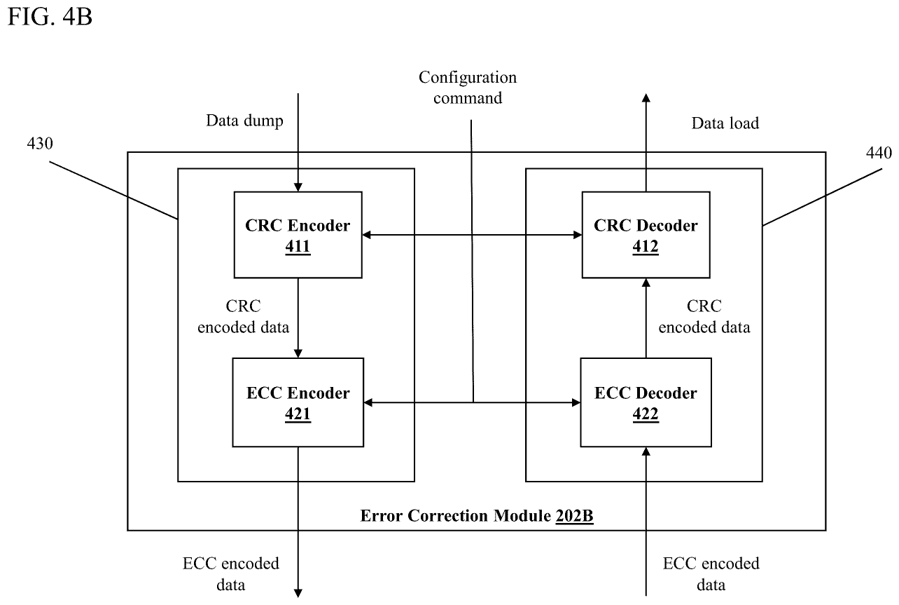

FIG. 4A is a block diagram showing an example of an error correction module, according to embodiments. As shown in FIG. 4A, an error correction module 202A may include a CRC module 410, and an ECC module 420. In embodiments, the CRC module 410 may include a CRC encoder 411 and a CRC decoder 412, and the ECC module 420 may include an ECC encoder 421 and an ECC decoder 422. In embodiments, the error correction module 202A may be an example of the error correction module 202 discussed above.

When the cache-coherent PMEM device 220 moves the data from the volatile memory module 122 to the non-volatile storage module 123, for example when the data is flushed or dumped from the volatile memory module 122 to the non-volatile storage module 123 based on a power failure being detected, the CRC encoder 411 may receive the data and perform CRC encoding on the received data to generate CRC-encoded data. Then, the ECC encoder 421 may receive the CRC-encoded data, and may perform ECC encoding on the CRC-encoded data to generate ECC-encoded data, which may be stored in the non-volatile storage module 123. In embodiments, the ECC encoded data may correspond to the encoded data discussed above with respect to the error correction module 202.

Then, when the cache-coherent PMEM device 220 moves the data from the non-volatile storage module 123 to the volatile memory module 122, for example based on the power failure being corrected, the ECC decoder 422 may receive the ECC-encoded data and perform ECC decoding on the ECC-encoded data to recover or reconstruct the CRC-encoded data. Then, the CRC decoder 412 may receive the CRC-encoded data, and may perform CRC decoding on the CRC-encoded data to recover or reconstruct the original data, which may then be stored in the volatile memory module 122.

In embodiments, the error correction module 202A may be configurable according to the I/O protocol. For example, one or more parameters of at least one of the CRC module 410 and the ECC module 420 may be configured based on a command according to the CRC.io protocol which may be received at the I/O interface 121 from the host device 110. According to embodiments, the configuring may include enabling or disabling at least one of the CRC module 410 and the ECC module 420, setting a type of the CRC encoding and decoding performed by the CRC module 410, setting a type of CRC code or algorithm used by the CRC module 410, setting a type of the ECC encoding and decoding performed by the ECC module 420, and setting a type of the ECC code or algorithm used by the ECC module 420.

In embodiments, the CRC module 410 may apply any type of CRC code or algorithm, for example at least one from among CRC-32 and CRC-16, however embodiments are not limited thereto. In embodiments, the ECC module 420 may apply any type of ECC code or algorithm, for example at least one from among a Bose-Chaudhuri-Hocquenghem (BCH) code, a Reed-Solomon (RS) code, and a polar code.

For example, the command according to the I/O protocol may include a value for a CRC option, and a value for an ECC option. Based on receiving the command according to the I/O protocol at the I/O interface 121, the processor 125 may check the value of the CRC option and the value of the ECC option in the command, and may configure the error correction module 202A accordingly.

Examples of possible values for the CRC option and the ECC option are provided below:

$$CRC Option = \{ 0 : disable , 1 : CRC - 16 , 2 : CRC - 32 \}$$

$$ECC Option = \{ 0 : disable , 1 : BCH \}$$

According to the examples above, based on the command according to the I/O protocol having a value of zero (‘0’) for the CRC option, the processor 125 may configure the CRC module 410 to be disabled. Based on the command according to the I/O protocol having a value of one (‘1’) for the CRC option, the processor 125 may configure the CRC module 410 to apply CRC-16 encoding and decoding. Based on the command according to the I/O protocol having a value of two (‘2’) for the CRC option, the processor 125 may configure the CRC module 410 to apply CRC-32 encoding and decoding.

Similarly, according to the examples above, based on the command according to the I/O protocol having a value of zero (‘0’) for the ECC option, the processor 125 may configure the ECC module 420 to be disabled. Based on the command according to the I/O protocol having a value of one (‘1’) for the ECC option, the processor 125 may configure the ECC module 420 to apply BCH encoding and decoding.

However, embodiments are not limited thereto, and any values may be used to indicate the configuration of the error correction module 202A.

According to embodiments, the cache-coherent PMEM device 220 may include reliability, availability, and service (RAS) features. In some embodiments, the RAS features may correspond to CXL RAS features, but embodiments are not limited thereto. For example, the RAS features may also provide CRC and error handling, but these RAS features may be used for link and protocol errors (e.g., link CRC check). As discussed above, embodiments may relate to protecting data transmission between the device memory (e.g., the volatile memory module 122) and the persistent backend storage (e.g., the non-volatile storage module 123), which may be orthogonal to the protections provided by RAS features.

FIG. 4B is a block diagram showing an example of an error correction module, according to embodiments. In embodiments, an error correction module 202B may be an example of the error correction module 202 discussed above. As shown in FIG. 4B, the error correction module 202B may be similar to the error correction module 202A discussed above, except that the error correction module 202B may include an encoder module 430 and a decoder module 440 instead of the CRC module 410 and the ECC module 420 discussed above. In embodiments, the encoder module 430 may include the CRC encoder 411 and the ECC encoder 421, and the decoder module 440 may include the CRC decoder 412 and the ECC decoder 422.

According to embodiments, the encoding and the decoding operations performed by the error correction module 202, and for example the ECC encoding and decoding operations and the CRC encoding and decoding operations performed by the error correction modules 202A and 202B, may be performed on-the-fly, and may have relatively low latency and relatively low computation cost in comparison with other operations of the cache-coherent PMEM device 220. For example, the encoding and the decoding operations performed by the error correction modules 202, 202A, and 202B may not add extra latency overhead to load operations and store operations performed by the host device 110 and the cache-coherent PMEM device 220.

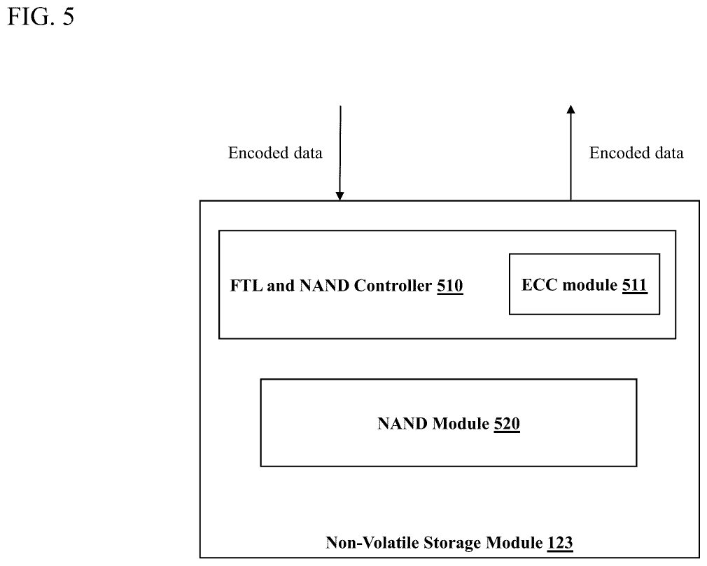

FIG. 5 is a block diagram showing an example of a non-volatile storage module, according to embodiments. In embodiments, the non-volatile storage module 123 may be, or may include, a NAND storage device such as an NVMe SSD device. For example, as shown in FIG. 5, the non-volatile storage module 123 may include a flash translation layer (FTL) and NAND controller 510 and a NAND module 520. In embodiments, the FTL and NAND controller 510 may include an ECC module 511.

In embodiments, the ECC module 511 may be used by the non-volatile storage module 123 to perform ECC encoding and decoding operations on data received and stored by the non-volatile storage module 123, which may improve the UBER of the non-volatile storage module 123. However, as discussed above, even with the ECC module 511, the UBER of the non-volatile storage module 123 may be higher than the UBER of the volatile memory module 122, and this error rate mismatch or gap may cause the overall UBER of the cache-coherent PMEM device 120 to be unsatisfactory.

Therefore, by adding the error correction module 202, or for example the error correction module 202A or the error correction module 202B, the cache-coherent PMEM device 220 may close the error rate gap between the non-volatile storage module 123 and the volatile memory module 122, and may therefore improve the overall error rate of the cache-coherent PMEM device 220, without any modifications to the non-volatile storage module 123, or for example any modifications to the FTL and NAND controller 510.

In embodiments, the encoding and decoding operations performed by at least one of the error correction modules 202, 202A, and 202B may have relatively low complexity and computational cost in comparison with the ECC encoding and decoding operations performed by the ECC module 511. However, the encoding and decoding operations performed by at least one of the error correction modules 202, 202A, and 202B may still be sufficient to reduce or eliminate the error rate gap between the non-volatile storage module 123 and the volatile memory module 122, and may therefore improve the overall error rate of the cache-coherent PMEM device 220 without adding additional latency to other operations performed by the cache-coherent PMEM device 220.

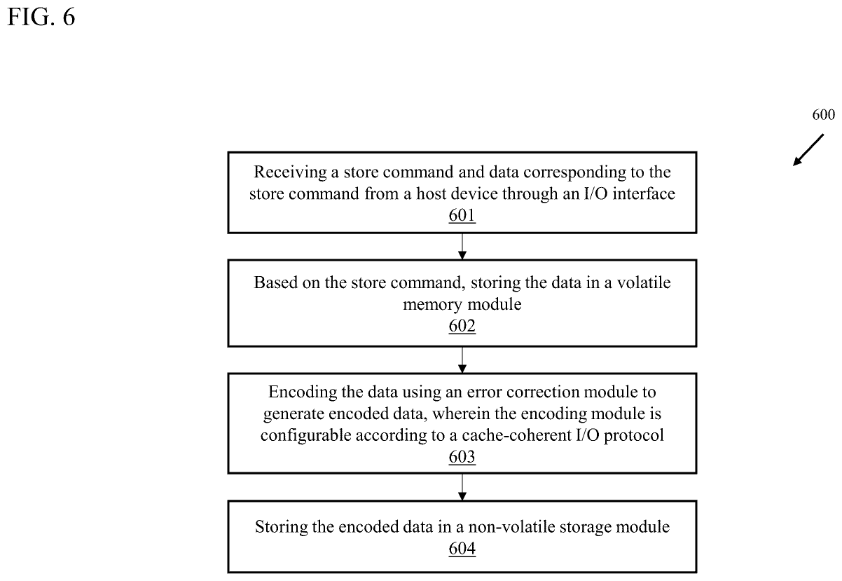

FIG. 6 is a flow chart of a process for operating a cache-coherent PMEM device, according to embodiments. In some implementations, one or more process blocks of FIG. 6 may be performed by one or more of the elements discussed above, for example one or more of the cache-coherent PMEM device 220 and the elements included therein.

As shown in FIG. 6, process 600 may include receiving a store command and data corresponding to the store command from a host device through an I/O interface according to a cache-coherent memory protocol (operation 601). In embodiments, the host device may correspond to the host device 110 discussed above. In embodiments, the I/O interface may correspond to the I/O interface 121 discussed above.

As further shown in FIG. 6, process 600 may include, based on the store command, storing the data in a volatile memory module (operation 602). In embodiments, the volatile memory module may correspond to the volatile memory module 122 discussed above. For example, the volatile memory module may be used to implement a device memory of the cache-coherent PMEM device, and may include a DRAM device.

As further shown in FIG. 6, process 600 may include encoding the data using an error correction module to generate encoded data, wherein the encoding module is configurable according to an I/O protocol (operation 603). In embodiments, the error correction module may correspond to at least one of the error correction modules 202, 202A, and 202B discussed above. In embodiments, the encoding of the data may provide error protection as the data is transferred between the volatile memory device to the non-volatile storage device. For example, the encoding of the data may allow detection and correction of errors which may occur in the data while it is transferred between the volatile memory device to the non-volatile storage device

As further shown in FIG. 6, process 600 may include storing the encoded data in a non-volatile storage module (operation 604). In embodiments, the non-volatile storage module may correspond to the non-volatile storage module 123 discussed above. For example, the non-volatile storage module may be used to implement a persistent backend storage of the cache-coherent PMEM device, and may include a NAND device such as an NVMe SSD.

In embodiments, the volatile memory module may be unable to maintain data when a power failure occurs, however the non-volatile storage module may be able to maintain data even during a power failure. Therefore, in some embodiments, operations 603 and 604 may be used to flush or dump data from the volatile memory module to the non-volatile storage module. Therefore, in some embodiments, operations 603 and 604 may be performed to ensure persistence of the data stored in the volatile memory module, for example based on detecting a change in a power state, for example a power failure, corresponding to the cache-coherent PMEM device, or based on receiving a flush command from the host device through the I/O interface, for example according to an I/O protocol.

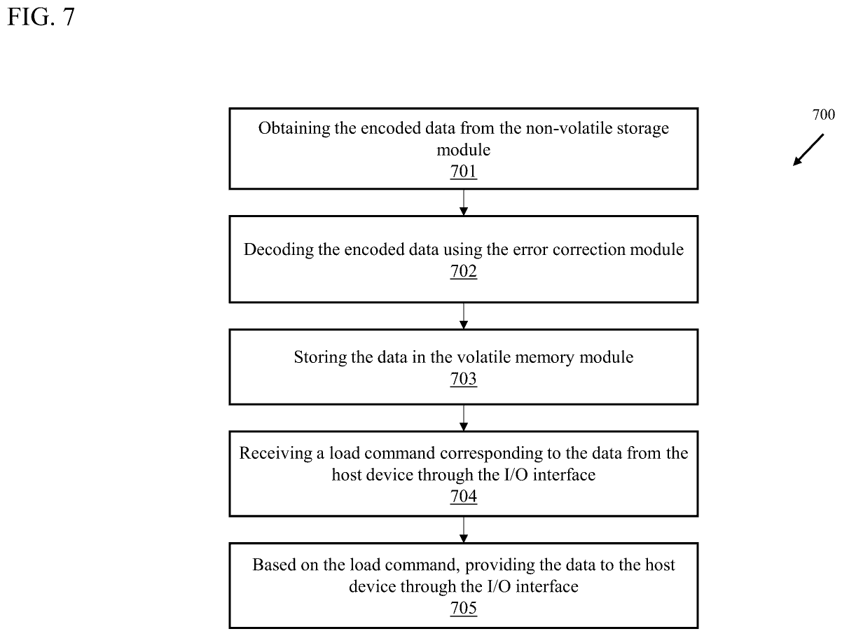

FIG. 7 is a flow chart of a process for operating a cache-coherent PMEM device, according to embodiments. In some implementations, one or more process blocks of FIG. 7 may be performed by one or more of the elements discussed above, for example one or more of the cache-coherent PMEM device 220 and the elements included therein.

As shown in FIG. 7, process 700 may include obtaining the encoded data from the non-volatile storage module (operation 701).

As further shown in FIG. 7, process 700 may include decoding the encoded data using the error correction module (operation 702). In embodiments, based on errors being detected, the decoding of the data may include reconstructing or restoring the original data.

As further shown in FIG. 7, process 700 may include storing the data in the volatile memory module (operation 702).

As further shown in FIG. 7, process 700 may include receiving a load command corresponding to the data from the host device through the I/O interface according to the cache-coherent memory protocol (operation 702).

As further shown in FIG. 7, process 700 may include, based on the load command, providing the data to the host device through the I/O interface (operation 702).

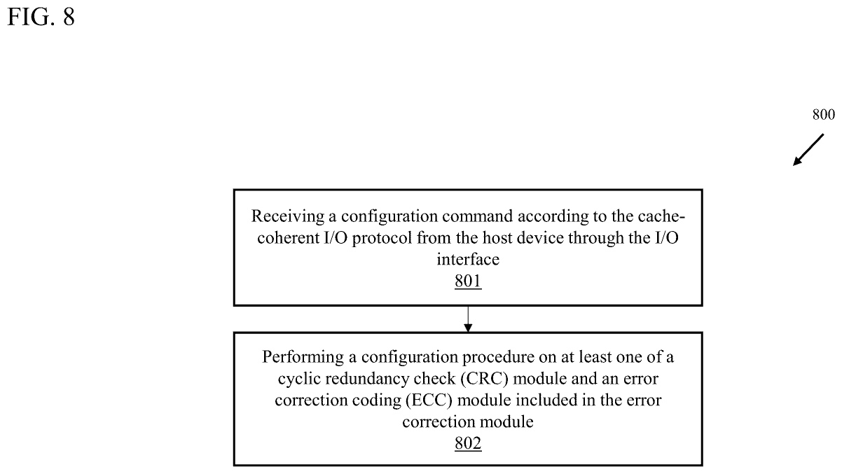

FIG. 8 is a flow chart of a process for operating a cache-coherent PMEM device, according to embodiments. In some implementations, one or more process blocks of FIG. 8 may be performed by one or more of the elements discussed above, for example one or more of the cache-coherent PMEM device 220 and the elements included therein.

As shown in FIG. 8, process 800 may include receiving a configuration command according to the I/O protocol from the host device through the I/O interface (operation 801). In embodiments, the configuration command may include values indicating parameters of the error correction module discussed above.

As further shown in FIG. 8, process 800 may include performing a configuration procedure on the error correction module (operation 802). In embodiments, the configuration procedure may include configuring the error correction module. For example, the configuration procedure may include at least one of enabling the error correction module, disabling the error correction module, and setting a type of error correction encoding and decoding applied by the error correction module.

Although FIGS. 6, 7, and 8 show example blocks of processes 600, 700, and 800, in some implementations, processes 600, 700, and 800 may include additional blocks, fewer blocks, different blocks, or differently arranged blocks than those depicted in FIGS. 6, 7, and 8. Additionally, or alternatively, two or more of the blocks of processes 600, 700, and 800 may be performed in parallel.

Accordingly, embodiments may provide a cache-coherent PMEM device which may include an error correction module which may perform error correction on data transferred between a device memory and a persistent backend storage included in the cache-coherent PMEM device. For example, a CRC scheme may be applied to data which is transmitted between the device memory and the persistent backend storage to achieve comprehensive data protection. As another example, a relatively low-cost ECC scheme such as at least one from among a BCH code, an RS code, and a polar code may be applied to data which is transmitted between the device memory and the persistent backend storage. Accordingly, embodiments may allow an error rate gap between the device memory and the persistent backend storage to be reduced or eliminated, and may therefore allow an overall error rate of the cache-coherent PMEM device to be improved.

Although some embodiments are described above as relating to cache-coherent PMEM devices, embodiments are not limited thereto. For example, embodiments may be used in any device in which a volatile memory device (e.g., a DRAM device) is connected to a non-volatile storage device (e.g., a NAND flash device such as an NVMe SSD device). For example, at least one of the error correction modules 202, 202A, and 202B may be included in other devices, for example dual-mode CXL-SSD devices, and other cache-coherent storages.

Embodiments of the subject matter and the operations described in this specification may be implemented in digital electronic circuitry, or in computer software, firmware, or hardware, including the structures disclosed in this specification and their structural equivalents, or in combinations of one or more of them. Embodiments of the subject matter described in this specification may be implemented as one or more computer programs, i.e., one or more modules of computer-program instructions, encoded on computer-storage medium for execution by, or to control the operation of data-processing apparatus. Alternatively or additionally, the program instructions can be encoded on an artificially-generated propagated signal, e.g., a machine-generated electrical, optical, or electromagnetic signal, which is generated to encode information for transmission to suitable receiver apparatus for execution by a data processing apparatus. A computer-storage medium can be, or be included in, a computer-readable storage device, a computer-readable storage substrate, a random or serial-access memory array or device, or a combination thereof. Moreover, while a computer-storage medium is not a propagated signal, a computer-storage medium may be a source or destination of computer-program instructions encoded in an artificially-generated propagated signal. The computer-storage medium can also be, or be included in, one or more separate physical components or media (e.g., multiple CDs, disks, or other storage devices). Additionally, the operations described in this specification may be implemented as operations performed by a data-processing apparatus on data stored on one or more computer-readable storage devices or received from other sources.

While this specification may contain many specific implementation details, the implementation details should not be construed as limitations on the scope of any claimed subject matter, but rather be construed as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described herein. Other embodiments are within the scope of the following claims. In some cases, the actions set forth in the claims may be performed in a different order and still achieve desirable results. Additionally, the processes depicted in the accompanying figures do not necessarily require the particular order shown, or sequential order, to achieve desirable results. In certain implementations, multitasking and parallel processing may be advantageous.

As will be recognized by those skilled in the art, the innovative concepts described herein may be modified and varied over a wide range of applications. Accordingly, the scope of claimed subject matter should not be limited to any of the specific exemplary teachings discussed above, but is instead defined by the following claims.

What is claimed is:

1. A cache-coherent persistent memory (PMEM) device, comprising:
an input/output (I/O) interface;
a volatile memory module;
an error correction module which is configurable according to an I/O protocol;
a non-volatile storage module; and
at least one processor configured to:
receive a store command and data corresponding to the store command from a host device through the I/O interface according to a cache-coherent memory protocol,
based on the store command, control the volatile memory module to store the data,
encode the data to generate encoded data using the error correction module, and
control the non-volatile storage module to store the encoded data.

2. The cache-coherent PMEM device of claim 1, wherein the at least one processor is further configured to:
obtain the encoded data from the non-volatile storage module;
control the error correction module to decode the encoded data to reconstruct the data;
control the volatile memory module to store the data;
receive a load command corresponding to the data from the host device through the I/O interface according to the cache-coherent memory protocol; and
based on the load command, provide the data to the host device through the I/O interface.

3. The cache-coherent PMEM device of claim 1, wherein the volatile memory module comprises a dynamic random access memory (DRAM) device, and
wherein the non-volatile storage module comprises a non-volatile memory express (NVMe) solid-state drive (SSD).

4. The cache-coherent PMEM device of claim 1, wherein an error rate of the volatile memory module is lower than an error rate of the non-volatile storage module, and
wherein an error rate of the cache-coherent PMEM device is higher than the error rate of the volatile memory module.

5. The cache-coherent PMEM device of claim 1, wherein the error correction module comprises:
a cyclic redundancy check (CRC) encoder configured to perform CRC encoding on the data based on a CRC code to generate CRC-encoded data;
wherein the encoded data is generated based on the CRC-encoded data.

6. The cache-coherent PMEM device of claim 1, wherein the error correction module comprises:
an error correction code (ECC) encoder configured to perform ECC encoding on the data based on an ECC code to generate ECC-encoded data,
wherein the encoded data comprises the ECC-encoded data.

7. The cache-coherent PMEM device of claim 1, wherein, based on receiving a configuration command according to the I/O protocol from the host device through the I/O interface, the at least one processor is further configured to perform a configuration procedure on at least one of a cyclic redundancy check (CRC) module and an error correction code (ECC) module included in the error correction module.

8. The cache-coherent PMEM device of claim 1, wherein, based on receiving a configuration command according to the I/O protocol from the host device through the I/O interface, the at least one processor is further configured to perform at least one from among enabling at least one of a cyclic redundancy check (CRC) module and an error correction code (ECC) module included in the error correction module, setting a type of a CRC code corresponding to the CRC module, and setting a type of an ECC code corresponding to the ECC module.

9. The cache-coherent PMEM device of claim 1, wherein the at least one processor is further configured to control the error correction module to encode the data, and to control the non-volatile storage module to store the encoded data, based on at least one from among detecting a change in a power state of the cache-coherent PMEM device, and receive flush command from the host device through the I/O interface.

10. A cache-coherent persistent memory (PMEM) device, comprising:
an input/output (I/O) interface;
a volatile memory module;
an encoder module and a decoder module which are configurable according to an I/O protocol;
a non-volatile storage module; and
at least one processor configured to:
based on receiving a store command and data corresponding to the store command from a host device through the I/O interface according to a cache-coherent memory protocol, control the volatile memory module to store the data,
based on at least one from among detecting a change in a power state of the cache-coherent PMEM device, and receiving a flush command from the host device through the I/O interface according to the I/O protocol, control the encoder module to encode the data to generate encoded data, and control the non-volatile storage module to store the encoded data,
control the decoder module to decode the encoded data to reconstruct the data,
control the volatile memory module to store the data, and
based on receiving a load command from the host device through the I/O interface according to the cache-coherent memory protocol, provide the data to the host device through the I/O interface.

11. The cache-coherent PMEM device of claim 10, wherein the volatile memory module comprises a dynamic random access memory (DRAM) device, and
wherein the non-volatile storage module comprises a non-volatile memory express (NVMe) solid-state drive (SSD).

12. The cache-coherent PMEM device of claim 10, wherein an error rate of the volatile memory module is lower than an error rate of the non-volatile storage module, and
wherein an error rate of the cache-coherent PMEM device is higher than the error rate of the volatile memory module.

13. The cache-coherent PMEM device of claim 10,
wherein the encoder module comprises:
a cyclic redundancy check (CRC) encoder configured to perform CRC encoding on the data based on a CRC code to generate CRC-encoded data, wherein the encoded data is generated based on the CRC-encoded data; and
wherein the decoder module comprises:
a CRC decoder configured to perform CRC decoding on the CRC-encoded data based on the CRC code to obtain the data.

14. The cache-coherent PMEM device of claim 10, wherein the encoder module comprises:
an error correction code (ECC) encoder configured to perform ECC encoding on the data based on an ECC code to generate ECC-encoded data, wherein the encoded data comprises the ECC-encoded data, and
wherein the decoder module comprises:
an ECC decoder configured to perform ECC decoding on the ECC-encoded data based on the ECC code to obtain the data.

15. The cache-coherent PMEM device of claim 10, wherein, based on a receiving a configuration command according to the I/O protocol from the host device through the I/O interface, the at least one processor is further configured to perform a configuration procedure on at least one of a cyclic redundancy check (CRC) module and an error correction code (ECC) module included in at least one of the encoder module and the decoder module.

16. The cache-coherent PMEM device of claim 10, wherein, based on a receiving a configuration command according to the I/O protocol from the host device through the I/O interface, the at least one processor is further configured to perform at least one from among:
enabling at least one of a cyclic redundancy check (CRC) module and an error correction code (ECC) module included in at least one of the encoder module and the decoder module,
setting a type of a CRC code corresponding to the CRC module, and
setting a type of an ECC code corresponding to the ECC module.

17. A method of operating a persistent memory (PMEM) device, the method comprising:
receiving a store command and data corresponding to the store command from a host device through an input/output (I/O) interface according to a cache-coherent memory protocol;
based on the store command, storing the data in a volatile memory module;
encoding the data using an error correction module to generate encoded data, wherein the error correction module is configurable according to an I/O protocol; and
storing the encoded data in a non-volatile storage module.

18. The method of claim 17, further comprising:
obtaining the encoded data from the non-volatile storage module;
decoding the encoded data using the error correction module;
storing the data in the volatile memory module; and
receiving a load command corresponding to the data from the host device through the I/O interface according to the cache-coherent memory protocol;
based on the load command, providing the data to the host device through the I/O interface.

19. The method of claim 17, wherein the volatile memory module comprises a dynamic random access memory (DRAM) device, and
wherein the non-volatile storage module comprises a non-volatile memory express (NVMe) solid-state drive (SSD).

20. The method of claim 17, further comprising:
receiving a configuration command according to the I/O protocol from the host device through the I/O interface; and
performing a configuration procedure on at least one of a cyclic redundancy check (CRC) module and an error correction code (ECC) module included in the error correction module.
